(19) United States
(12) Patent Application Publication
(10) Pub. No.: US 2013/0170330 A1
(43) Pub. Date: Jul. 4, 2013

(54) CONTROLLED CONTACT OR CONTACTLESS FORCE TRANSMISSION IN A TIMEPIECE

(71) Applicants: Thierry Hessler, St-Aubin (CH); Michel Willemin, Preles (CH); Jean-Luc Helfer, Bienne (CH); Francois Gueissaz, Wavre (CH); Thierry Conus, Lengnau (CH)

(72) Inventors: Thierry Hessler, St-Aubin (CH); Michel Willemin, Preles (CH); Jean-Luc Helfer, Bienne (CH); Francois Gueissaz, Wavre (CH); Thierry Conus, Lengnau (CH)

(73) Assignee: The Swatch Group Research and Development Ltd, Marin (CH)

(21) Appl. No.: 13/812,411

(22) PCT Filed: May 11, 2011
(86) PCT No.: PCT/EP11/57578

§ 371 Date: Jan. 25, 2013

(30) Foreign Application Priority Data
Jul. 30, 2010 (CH) 01250/10

(51) Int. Cl. B05D 5/12; G04B 31/00

(52) U.S. Cl. CPC B05D 5/12; G04B 31/00
USPC 368/324; 427/58

(57) ABSTRACT

The invention concerns a method of making a controlled or reduced contact or contactless transmission in a timepiece movement.

At least one pair of opposing cooperating surfaces of said timepiece movement, one of which drives the other or is supported thereby, is made or transformed by applying a surface or through treatment conferring an electrostatic and/or magnetic charge of the same polarisation and/or magnetisation on said opposing cooperating surfaces, such that said opposing components tend to repel each other when they are moved closer to each other.

Said treatment consists in creating or depositing at least one thin layer on said cooperating surface and/or on said opposing cooperating surface.

The invention also concerns a timepiece mechanism incorporating at least one pair of opposing components, one of which drives the other or is supported thereby, said pair being made or transformed by implementing this method.

### FIELD OF THE INVENTION

The invention concerns a method of making a controlled or reduced contact or contactless transmission in a timepiece movement.

The invention also concerns a timepiece movement incorporating at least one pair of components made or transformed by implementing this method.

### BACKGROUND OF THE INVENTION

The invention concerns the field of watchmaking, and more specifically the field of mechanical movements.

The friction behaviour of the components of a timepiece mechanism has a direct influence on the sizing, performance, operating quality, regularity of rate, and longevity thereof.

Friction results first of all in a loss of efficiency, which makes it necessary to oversize not only the energy storage means, such as mainsprings or similar, but also the means for transmitting this energy inside the entire mechanism. This results in larger sections and diameters than are necessary for operation of the timepiece. Naturally, the greater the friction, the more the autonomy of the timepiece is affected and the lower the power reserve will be.

Wear affects all of the components that are subject to friction, impact stress, or to high contact pressure. Wear is a recurrent problem which, long term, results in deterioration in the quality of a movement, particularly in terms of isochronism. Although wear concerns all of the moving parts of a movement, it mainly concerns the components of the escape mechanisms and regulating members, and the toothings of the wheels and pinions, and the arbours and pivots.

It is known to minimise friction by means of suitable surface treatments. In fact, the possibility of lubrication is very limited in the field of watchmaking, and cannot be exploited optimally for long term action.

Minimising any actual contact has also been envisaged, either by eliminating contact, or by decreasing the length of contact, or by decreasing contact pressure.

The elimination of any contact has been attempted in the field of power transmission, with magnetic type solutions, using pivotal driving of a first driven receiver wheel or pinion, which includes magnetised surfaces, by a second driving transmitter wheel or pinion, driven by an energy source and also including magnetised surfaces, wherein the first and second wheels or pinions devices come into proximity with each other, either in adjoining planes as in CN Patent No. 2006 1011 2953.2 in the name of Li Lingqun, or substantially tangentially as in the same document, or even in more complex, spiral geometries, as in JP Patent No 0130 332 in the name of Shoei Engineering Co Ltd.

The combination of toothings and magnetic surfaces for transmission applications or electromechanical power machines, is described in GB Patent No. 2 397 180 in the name of Newman and CN Patent No. 2 446 326 in the name of Qian Hui. In this latter document each tooth of a wheel includes, on either side of a radial line, two sectors of different polarity, which are arranged to counter similar sectors of the same polarity of an opposing wheel, with which the toothing interacts.

As regards the bearings, radial magnetic levitation bearings are known from CN Patent No. 2 041 825 in the name of Nantong Industry and Commerce, or both axial and radial magnetic levitation bearings as in JP Patent No. 7 325 165 in the name of Seikosha K K.

Since the 17th century, for example with the achievements of Adam Kochanski, the field of watchmaking has been familiar with magnetic stop members for limiting the travel of the balance, making a balance spring redundant.

However, in these various approaches, the use of massive solid magnets results in a significant requirement for space, and complexity in the making of each component.

### SUMMARY OF THE INVENTION

It is an object of the present invention to overcome all or part of the aforementioned drawbacks, by proposing a method of making timepiece movement components, or transforming such components, in order to limit or eliminate any contact between opposing parts, while ensuring the operation thereof.

The invention therefore concerns a method of making a controlled or reduced contact or contactless transmission in a timepiece movement, characterized in that at least one pair of opposing surfaces, called cooperating surfaces, of the same component or a pair of opposing components of said timepiece movement are made or transformed, wherein one of said surfaces drives the other or abuts against the other, by applying a surface or bulk treatment to at least one of said opposing surfaces forming said pair to confer thereon an electrostatic and/or magnetic charge, so that said surface tends to repel said other opposing surface of said pair when they are moved closer to each other.

According to one feature of the invention, at least one of said pair of opposing cooperating surfaces of the same component or of a pair of opposing components is made or transformed, by applying a surface or bulk treatment conferring an electrostatic and/or magnetic charge of the same polarisation and/or magnetisation on said opposing cooperating surfaces, such that said opposing surfaces tend to repel each other when they are moved closer to each other.

According to a feature of the invention, when said pair of opposing surfaces are made or transformed, each of said opposing cooperating surfaces is subjected to a surface or bulk treatment.

According to a feature of the invention, during said surface treatment, the surface is coated with at least one thin layer, called the activation layer, of electrically or magnetically charged particles, of the same polarisation or respectively the same magnetisation as each other, such that said opposing cooperating surfaces tend to repel each other when they are moved closer to each other, or at least one such thin activation layer is created.

According to another feature of the invention, said surface or bulk treatment consists in creating or depositing on each of said opposing cooperating surfaces a plurality of thin layers of electrically and/or magnetically charged particles, in pairs with the same polarisation or respectively magnetisation, such that said opposing cooperating surfaces tend to repel each other when they are moved closer to each other.

Advantageously, according to this method, any friction between the components forming this pair of opposing components which cooperate with each other is decreased or eliminated, on at least one cooperating surface of one and at least one opposing cooperating surface of the other.

According to a feature of the invention, said thin layer is an electret layer arranged to generate a surface charge density of between 0.1 and 50 mC/m^{2.}

According to a feature of the invention, said surface or bulk treatment consists in creating or depositing on said cooperating surface or on said opposing cooperating surface at least one thin magnetically active layer having a remanent field Br higher than or equal to 1 T, and a coercitive excitation Hc higher than or equal to 100 kA/m.

According to another feature of the invention, said thin layer includes at least one fluoropolymer film.

According to another feature of the invention, the thickness of said thin layer is less than or equal to 20 μm.

The invention also concerns a timepiece mechanism incorporating at least one pair of opposing components, one of which drives the other or abuts against the other, said pair being made or transformed by implementing this method.

The invention offers the advantage of making it possible to retain the size of each component, since the thickness of the thin layer is sufficiently small that it does not alter the kinematics.

The combination of a particular arrangement of the opposing surfaces for controlling the friction thereof, either by repulsion or attraction between them, with a tribological layer, provides good control of friction and the efficiency of the mechanism, and minimal wear is obtained.

Other features and advantages will appear clearly from the following description, given by way of non-limiting illustration.

### DETAILED DESCRIPTION OF PREFERRED EMBODIMENTS

The invention concerns the field of watchmaking, and more specifically the field of mechanical movements.

The invention therefore concerns a method of making a controlled contact transmission, particularly a reduced contact or contactless transmission, in a timepiece movement.

According to a preferred implementation of the invention, at least one pair of opposing surfaces, called cooperating surfaces, of the same component or a pair of opposing components of said timepiece movement are made or transformed, wherein one of said surfaces drives the other or abuts against the other, by applying a surface or bulk treatment to at least one of said opposing surfaces forming said pair to confer thereon an electrostatic and/or magnetic charge, such that said surface tends to repel the other opposing surface of said pair when they are moved closer to each other.

In a particular implementation of the invention, at least one said pair of opposing cooperating surfaces of the same component or of a pair of opposing components is made or transformed, by applying a surface or bulk treatment conferring an electrostatic and/or magnetic charge of the same polarisation and/or magnetisation on said opposing cooperating surfaces, such that said opposing surfaces tend to repel each other when they are moved closer to each other.

During implementation of this method, any friction between the components forming this pair of opposing components is reduced or eliminated. These components cooperate with each other via at least one cooperating surface of one and at least one opposing cooperating surface of the other.

In short, this pair of opposing components is protected by a decrease in friction, as is the entire timepiece movement.

This method is applicable, either when the components are being made, or when the components are being transformed. The term “made” will be used indiscriminately for both cases hereinafter.

For example, in preferred and non-limiting applications, the pairs of opposing surfaces or opposing components may consist of:
two toothed wheels;
two cams;
one cam and one lever;
two levers;
one arbour or staff and one pivot;
pallets and an escape wheel;
a pallet fork and a balance roller;
a wheel and a whip;
a heart-piece cam and a hammer;
two consecutive coils of the same spring, particularly a hairspring or a balance spring;
a star-wheel and a finger.

According to a feature of the invention, preferably, when a pair of opposing surfaces are made or transformed, each of the opposing cooperating surfaces is subjected to a surface treatment and/or a bulk treatment.

When this pair of opposing surfaces is subjected to a surface treatment, each opposing surface is coated with at least one thin layer, called the activation layer, of electrically or magnetically charged particles, of the same polarisation or respectively the same magnetisation as each other, such that these opposing cooperating surfaces tend to repel each other when they are moved closer together, or at least one such thin activation layer is created.

When this pair of opposing surfaces is subjected to a bulk treatment, one part of the structure of each component concerned is subjected to an electrization and/or magnetisation treatment, on at least one thin layer, called the activation layer, including, after said treatment, electrically or magnetically charged particles, of the same polarisation or respectively the same magnetisation as each other, such that these opposing cooperating surfaces tend to repel each other when they are moved closer together, or at least one such thin activation layer is created.

Naturally, according to the invention, one of the opposing surfaces may be surface treated while the other opposing surface is bulk treated, or both opposing surfaces can be surface treated, or both opposing surfaces can be through treated.

The notion of charged particles also applies to the growth of a crystal made of at least two elements, which are not separately charged, but are charged at the moment of crystalline growth. It also applies to a charged particle deposition with heat activation or fixing.

This activation layer may already be active such as, in particular, a magnetised layer, or activatable, i.e. activated after the creation or deposition thereof, particularly for electrets as will be seen below.

In particular, this surface treatment consists in creating or depositing on each of the opposing cooperating surfaces a plurality of thin layers of electrically and/or magnetically charged particles, in pairs with the same polarisation or respectively the same magnetisation, such that these opposing cooperating surfaces tend to repel each other when they are moved closer together.

In particular, in a similar manner, the bulk treatment consists in creating these thin layers throughout a component. This through treatment consists in subjecting one part of the structure of each component concerned to an electrization and/or magnetisation treatment, in a plurality of thin layers, including, after this treatment, electrically and/or magnetically charged particles, in pairs of the same polarisation or respectively the same magnetisation, such that said opposing cooperating surfaces tend to repel each other when they are moved closer to each other.

Although the preferred embodiment of the invention is that involving surface treatment of all or part of the opposing cooperating surfaces, it is clear that a bulk treatment may also achieve the desired effects. However, a bulk treatment is not always possible because of unwanted interference with the other components of a timepiece movement, which is why the surface treatment case is more particularly set out here. This surface treatment may concern one or several peripheral layers of the component concerned. A multi-layer treatment may allow more homogeneous force to be generated, which is more stable over time, and less dependent upon small local changes in charge or magnetisation density.

It is thus clear that, although a layer that is considered small is an advantageous solution because it is directly compatible with existing components, using their tolerance intervals, this thin layer is a preferred solution, but not the only one that can be used to implement the invention.

Depending upon the method of elaboration, the thin layer is an electrically charged layer subjected to an electric force and then called an electret, or a thin magnetised layer subjected to a magnetic force, or a thin layer which is both electrically and magnetically charged. When the thin layer is magnetically charged, it is preferably made in the form of a hard magnetic material, such as neodymium-iron-boron or suchlike. A “magnetic charge” means a magnetic dipole, which is not point-shaped, although it may be of small dimensions.

In the implementation of the invention, at least one thin layer of this type is activated so as to it give it the required polarisation or magnetisation. In the case of an electret, the layer or component is electrized in a high electric field, possibly combined with a heat treatment, and/or contact with a liquid.

As regards the magnetic layers, some are already polarised at the end of the deposition method on the cooperating surfaces, and others have to be polarised after the end of the method. One particular polarisation method consists in subjecting the component to a laser field, which creates interference allowing grains to be easily oriented under the action of an external magnetic field.

In a particular embodiment, at least one thin layer of this type is activated after deposition on the cooperating surface so as to confer the required polarisation or magnetisation.

As regards this activation, those skilled in the art may refer to the teaching relating to the sensor, activator, memory-disc, or antenna industries in which thin layers are used and the treatment thereof has been the subject of publications which are directly applicable here.

For electrically charged thin layers or electrets, the following articles may be cited, particularly concerning “Corona” type activations:
[symbol] Non-contact electrostatic micro-bearing using polymer electret [symbol] , by Messrs. Yukinori Tsurumi, Yuji Suzuki and Nobuhide Kasagi, Department of Mechanical Engineering, The University of Tokyo, published in “Proc” IEEE Int. Conf. MEMS 2008, Tucson, 2008, pp 511-514;
[symbol] Low-resonant-frequency micro electret generator for energy harvesting application [symbol] , by Messrs. M. Edamoto, Y. Suzuki, N. Kasagi, Department of Mechanical Engineering, The University of Tokyo, Messrs. K. Kashiwagi, Y. Morizawa, Research Centre, Asahi Glass Corporation, Kanagawa, Messrs. T. Yokohama, T. Seki, and M. Oba, Core Technology Centre, Omron Corporation, Kyoto, published under reference [symbol] 978-1-4244-2978-3/09 ©2009 IEEE, pp 1059-1062 [symbol] ;
[symbol] A 2D electret-based resonant micro energy harvester [symbol] , by Messrs. U. Bartsch, J. Gaspar, and O. Paul, Department of Microsystems Engineering (IMTEK), University of Freiburg Germany, published under reference “978-1-4244-2978-3/09 ©2009 IEEE, pp 1043-1046 [symbol] .

For magnetically charged thin layers, the following articles in particular may be cited:
[symbol] High performance thin film magnets [symbol] , by Messrs. S. Fähler, V. Neu, M. Weisheit, U. Hannemann, S. Leinert, A. Singh, A. Kwon, S. Melcher, B. Holzapfel, and L. Schultz, IFW Dresden, published under reference “18^{th} Workshop on High Performance Magnets and their Applications, Annecy France 2004, pp 566-576”;
“Exchange coupled nanocomposite hard magnetic alloys”, by Messrs. I. Betancourt and H. A. Davies, Department of Engineering Materials, University of Sheffield UK, published under reference “Materials Science and Technology, 2010, Vol 26, No 1, pp 5-19, ©2010 Institute of Materials, Minerals and Mining.

Preferably, in a first embodiment where the thin electret layer is electrically charged (ion or electron implantations, “Corona” method, by liquid contact, or other), this thin layer is arranged to generate a charge surface density on the order of 10 mC/m² and advantageously within a range of 0.1 to 50 mC/m², with this value of 10 mC/m² for example allowing an electrostatic force higher than or equal to 10 μN/mm² to be obtained for a distance greater than or equal to 100 μm.

In the case of electrets, the activation layer is electrically polarised and may be formed of SiO₂, As₂S₃, polymers such as PET, fluorinated polymers such as Teflon, [symbol] CYTOP® [symbol] by [symbol] Asahi Glass® [symbol] , parylene [symbol] HT® [symbol] by [symbol] Speciality Coating Systems [symbol] . The parylene can be deposited to conform to the surface at ambient temperature, or suchlike.

In a particular embodiment, at least one thin layer is a SiO₂ electret on a silicon base.

The SiO₂ layer can be made by oxidizing silicon in an oxygen atmosphere furnace, or in the form of a deposition.

A charged activation layer may, depending upon the case, be either enclosed between two metallic layers each of a thickness of between 10 and 1000 nm, or arranged at the periphery of the component, above a single metallic layer having a thickness of between 10 and 1000 nm, the total thickness of the activation layer and the metallic layer(s) being in both cases preferably less than 20 μm. The component itself may also be conductive.

The electrostatic charge may be transferred to a polysilicon layer embedded in an insulator such as SiO₂, in a similar manner to EEPROM type electronic memories. Islands of arbitrary size may be formed, by a photolithographic method, as used in microelectronics, or suchlike.

In a second embodiment of the invention wherein the thin layer is magnetised, the surface or bulk treatment preferably consists in creating or depositing on the cooperating surface and/or the opposing cooperating surface, and preferably on both, at least one magnetically active thin layer having a remanent field Br on the order of 1 T, notably higher than or equal to 1 T, and a coercive excitation Hc of several hundreds of kA/m, notably higher than or equal to 100 kA/m.

The polarisation is, according to the particular case, either carried out parallel to the plane or perpendicular to the plane. A tangential torque effect produces the effect of repulsion, or conversely, of attraction, which is sought in implementing the invention. For polarisation perpendicular to the plane, there is repulsion if the magnets are opposing magnets or attraction in the opposite case. For polarisation parallel to the plane, there is repulsion and torque if the magnets are in the same direction, or attraction if they are in opposite directions.

In the case of magnets, the layer may be formed of magnetic materials such as FePt, and/or CoPt, and/or SmCo, and/or NdFeB, which may be deposited as they are or in a field or subsequently polarised, and notably by electroplating, physical deposition (triode sputtering, pulsed laser, or another method) or other means, and either magnetised immediately at the time of deposition, or magnetised subsequently, for example by heat annealing or in a laser beam sub-field or other means. Polarisation may be mainly in the plane of the layer or perpendicular thereto.

In a third embodiment which is more complex to implement, the thin layer is both electrically and magnetically charged.

The activation layer or electrically and/or magnetically activated layer may, in an advantageous variant, be coated with a tribological layer. This version is advantageous where contact is not completely eliminated, but kept at a very low level of contact force. Particularly in the case of a timepiece escapement mechanism, this approach considerably improves the efficiency of the escapement compared to usual embodiments, by reducing friction. For example, a silicon oxided escapement coated with a material having advantageous suitable tribological properties such as diamond-like-carbon (DLC) has entirely satisfactory behaviour and increased efficiency.

The depth at which the electrified and/or magnetised activation layer is located, the outermost of one of the cooperating surfaces, is preferably low, typically comprised between 0.1 and 5 μm, so that the force is efficient, but the depth must be sufficient for a tribological layer to survive natural wear.

The thickness of this thin layer is less than 100 μm, and preferably between 0.1 and 20 μm. Naturally, the total thickness of the thin layers between the two opposing components must remain compatible with kinematics, and not exceed the operational play between them, and preferably, remain less than half the value of this play in the most unfavourable conditions.

The surface area of the layer naturally depends on the component on which the treatment is carried out and the type of deposition. According to the particular case, the layer may advantageously be separated into islands. For example, for an embedded polysilicon system, it may wise to separate the charge reservoirs formed by the polysilicon islands laterally so as to improve efficiency in the event that part of the reservoirs leaks (loss of charge). For timepiece applications, the largest dimension values of the activation layer surface area or, when the layer is thus separated into islands the largest dimension of the islands, are preferably comprised between 0.01 mm and 1 mm. Indeed, island dimensions comprised between 0.01 mm and several millimetres are generally suitable, given of course that the repulsion force is proportional to the surface area concerned.

The basic material of the component to which the thin electrized and/or magnetised layer is applied, which is itself possibly protected by a peripheral tribological layer, may be, for timepiece applications, one of the materials used or being developed for the watchmaking industry: single crystal silicon, single crystal quartz, polysilicon, metals, metal alloys, ceramics, plastics, glasses, amorphous materials, amorphous metal, “LIGA”. This list is not restrictive.

The thin layer may be arranged locally on a component for example in the case of an electret, so as to improve the lifetime of the product.

The magnetic repulsion force may also exist if one of the two opposing components is in a diamagnetic state, and if only the other of the two opposing components has at least one magnetised layer. The method of making a reduced contact or contactless transmission in a timepiece movement is thus characterized in that at least one pair of opposing surfaces of said timepiece movement is made or transformed, one of which drives the other or abuts against the other, by applying a surface or bulk treatment conferring a magnetic charge on one of the opposing cooperating surfaces, the other of said opposing surfaces being in a diamagnetic state, such that said opposing components tend to repel each other when they are moved closer to each other.

In a particular embodiment, a layer of polysilicon embedded in oxide is charged, in a similar manner to EEPROM type electronic memories.

Although the invention is preferably devised to apply to a pair of opposing components, it is also applicable, as regards the nature of the treatment using a thin electrized or magnetised layer, to a single isolated component, which cooperates with an opposing part which does not receive the same thin electrified or magnetised layer treatment, but which is more conventionally electrized in the bulk, or traversed by an electric current, or which is magnetised in the bulk, or which is under the influence of a magnetic field generated by a magnet or by an electric current.

For example, this case may more particularly concern a shaft or arbour, to which the treatment method using an electrized or magnetised thin layer according to the invention is applied, and which cooperates with a massive solid part such as a plate or a bridge, subjected to electrical potential and/or magnetisation. Preferably, in a timepiece containing numerous components that are sensitive to magnetic fields which interfere with the rate and regularity of the movement, it is preferable to give the solid part electrical rather than magnetic polarity, and thus to choose a thin electrized layer treatment for the shaft or arbour concerned.

The application of the invention to pairs of arbours and bores is particularly advantageous, since it enables pivots to be either omitted, or made of smaller size, because of the very low residual contact stresses achieved by the invention. Numerous timepiece mechanisms, which include blind or through machining, in components made of electro-magnetic material, may advantageously be transformed, without altering their dimensions, and polarised and/or magnetised so as to repel arbours of the same polarisation or magnetisation, both radially and axially at the end of the arbour, which means that an arbour can be held levitated in its housing.

Advantageously, the component or pair of components including opposing surfaces is made in micro-machinable material derived from MEMS technologies, or in silicon or quartz, or in a material fabricated by the LIGA method. In fact, the use of these materials is appreciated because the inertia thereof is lower than steels or other alloys, and moreover, these support-materials are particularly suitable for securing the thin layers according to the invention.

In an advantageous variant, micro-magnets are made by photolithography or within a structure made by photolithography.

Particularly, at least one pair of opposing cooperating surfaces of the same component or a pair of opposing components are transformed or made by applying a surface treatment over a thickness of less than or equal to 20 μm.

The invention also concerns a timepiece mechanism incorporating at least one pair of opposing components, one of which drives the other or abuts against the other, said pair being made or transformed by implementing this method.

The invention offers the advantage of making to possible to keep the initial dimensions of each component unchanged, when the thickness of the thin layer is very small, preferably much lower than the value of the operational play between the surfaces or the opposing components. Implementation of the invention improves the overall efficiency of the timepiece movement, and either allows the power reserve of the movement to be increased, or a smaller size to be adopted for the barrel or energy storage means, so as to obtain a more compact movement, in particular in application to a lady's watch.

It is clear that, depending upon the dimensions of the thin layers and according to the level of their electric and/or magnetic activation, the transmission of stress in the movement, at each pair of opposing components concerned, may be achieved either truly without contact, which is the ideal case, or with very greatly minimised contact compared to the same movement, with the same kinematics, to which the method of the invention has not been applied. In all cases, a significant saving in terms of friction, energy and wear is achieved as a result of the invention.

The phenomenon of repulsion between components also allows some shocks or impacts to be absorbed, which also results in less wear and improved longevity of the movement, and above all in consistent performance over time.

Naturally, the features described above are applicable to the reverse problem, when it is sought to attract the opposing surfaces to each other.

In particular, mechanical plays in transmissions or similar mechanisms can be taken up by arranging the opposing surfaces to attract each other.

This arrangement may be advantageous where the operation of a mechanism requires an impact, for example a hammer on a heart-piece, a jumper on a star wheel or on a date disc, or in a strike mechanism, or similar, and where, after said impact, an attraction force created by electrets or magnetised surfaces returns the components concerned to their position, particularly without any play. The applications thus concern, in a non-limiting manner, the control of plays and friction forces in certain mechanisms.

It is thus clear that the invention enables control to be obtained of friction forces, whether in the sense of reducing or eliminating said forces, or in the sense of stabilising or increasing them.

Of course, this invention is not limited to the illustrated example but is capable of various variants and alterations that will appear to those skilled in the art.

1-21. (canceled)

22. A method of making a controlled or reduced contact or contactless transmission in a timepiece movement, the method comprising:
applying a first surface or bulk treatment to a first surface, thereby obtaining a first treated surface with an electrostatic charge capable of repelling a second surface,
wherein the first and second surfaces are opposing cooperating surfaces of the same component or of a pair of opposing components suitable for a timepiece, and
the first surface is configured to drive or abut against the second surface or the second surface is configured to drive or abut against the first surface.

23. The method according to claim 22, wherein the first treated surface has a polarization of the second surface.

24. The method according to claim 22, further comprising applying a second surface or bulk treatment to the second surface, thereby obtaining a second treated surface.

25. The method according to claim 24, wherein the first surface or bulk treatment and the second surface or bulk treatment together comprise, as a surface treatment, coating each surface with a thin activation layer of electrically charged particles of the same polarization as each other, thereby obtaining a first treated surface and a second treated surface capable of repelling each other, or thereby obtaining a first treated surface, a second treated surface, or both that comprises a thin activation layer.

26. The method according to claim 24,
wherein the first surface or bulk treatment comprises, as a bulk treatment, electrizing at least a part of the first surface on a thin activation layer, thereby obtaining electrically charged particles with a polarization;
the second surface or bulk treatment comprises, as a bulk treatment, electrizing at least a part of the second surface on a thin activation layer, thereby obtaining electrically charged particles with the polarization of the electrically charged particles of the first surface; and
the first and second surface or bulk treatments together comprise obtaining a first treated surface and a second treated surface capable of repelling each other, or comprise obtaining a first treated surface, a second treated surface, or both that comprises a thin activation layer.

27. The method according to claim 24, wherein either
the first surface or bulk treatment is a surface treatment and the second surface or bulk treatment is a bulk treatment, or
the second surface or bulk treatment is a surface treatment and the first surface or bulk treatment is a bulk treatment.

28. The method according to claim 24, wherein the first and second surface or bulk treatments together comprise creating or depositing a plurality of thin layers of electrically charged particles with the same polarization on the first and second surfaces, thereby obtaining the first and second treated surfaces that are capable of repelling each other.

29. The method according to claim 22, where the first and second surface or bulk treatments together comprise electrizing the first and second surfaces on a plurality of thin layers, thereby obtaining electrically charged particles of the same polarization in the first and second surfaces such that the first and second treated surfaces are capable of repelling each other.

30. The method according to claim 22,
wherein the first surface, the second surface, or both comprises a thin activation layer of electrically charged particles, and
wherein the method further comprises activating the thin activation layer after deposition on the first surface, the second surface, or both, thereby obtaining a polarized thin activation layer.

31. The method according to claim 22,
wherein the first surface, the second surface, or both comprises a thin activation layer of electrically charged particles, and
wherein the thin activation layer is an SiO₂ electret on a silicon base.

32. The method according to claim 22,
wherein the first surface, the second surface, or both comprises a thin activation layer of electrically charged particles as an outermost layer at a depth of between 0.1 and 5 μm underneath a tribological surface layer.

33. The method according to claim 22,
wherein the first surface, the second surface, or both comprises a thin activation layer of electrically charged particles, and
wherein a largest surface area dimension value of the activation layer, or a largest dimension of islands of the activation layer, is between 0.01 mm and 1 mm.

34. The method according to claim 22,
wherein the first surface, the second surface, or both comprises a thin activation layer of electrically charged particles, and
a thickness of the thin activation layer is less than or equal to 20 μm.

35. The method according to claim 22,
wherein the first surface, the second surface, or both comprises a thin activation layer of electrically charged particles, and
the method further comprises activating the thin activation layer by electrization, by subjecting the activation layer to an electric field, by implanting ions or electrons in the activation layer, by the “Corona” method, or by any combination thereof, thereby generating a surface charge density of between 0.1 and 50 mC/m².

36. The method according to claim 22,
wherein the first surface, the second surface, or both comprises a thin activation layer of electrically charged particles,
the thin activation layer comprises SiO₂ or As₂S₃, a fluoropolymer, teflon, “CYTOP®,” parylene “HT®,” or any combination thereof, and
the method further comprises electrizing the activation layer.

37. The method according to claim 22,
wherein the first surface, the second surface, or both comprises a thin activation layer of electrically charged particles,
the activation layer comprises a polysilicon layer embedded in an insulator or SiO₂,
the polysilicon layer comprises islands of arbitrary size obtained by a process comprising photolithography, and
the method comprises electrizing the polysilicon layer, thereby obtaining a polysilicon layer with an electrostatic charge.

38. The method according to claim 22,
wherein the first surface, the second surface, or both comprises a thin activation layer of electrically charged particles,
the method comprises creating or depositing a thin active layer on the first surface, the second surface, or both, and
the thin active layer has a coercitive excitation Hc higher than or equal to 100 kA/m.

39. The method according to claim 22,
wherein the first surface, the second surface, or both comprises a thin activation layer of electrically charged particles, and
the thin activation layer comprises FePt, CoPt, SmCo, NdFeB, or any combination thereof, deposited in an original state thereof or in an electric field, or subsequently polarized.

40. The method according to claim 22, wherein the component or pair of opposing components comprises a micro-machinable material derived from MEMS technologies, single crystal silicon, single crystal quartz, polysilicon, or a material obtained by a process comprising a LIGA method.

41. The method according to claim 22, comprising applying a surface treatment over a thickness of less than or equal to 20 μm to the first surface, the second surface, or both.

42. A timepiece mechanism, comprising:
a pair of opposing components that comprises a first and second surface obtained by a process comprising the method of claim 22,
wherein one component of the pair of opposing components is configured to drive or support another component of the pair of opposing components.
